(19) United States
(12) Patent Application Publication
(10) Pub. No.: US 2009/0020613 A1
(43) Pub. Date: Jan. 22, 2009

(54) THIN FLEXIBLE SMART CARD AND PACKAGING METHOD THEREOF

(75) Inventors: Shun-Chi Chang, Taipei (TW); Min-Shun Wu, Taipei (TW); Yung-Sheng Kuo, Taipei (TW); Chi-Kuang Liu, Taipei (TW); Ming-Tsai Wang, Taipei (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Yuen Foong Yu Paper Mfg Co.

(21) Appl. No.: 11/970,385

(22) Filed: Jan. 7, 2008

(30) Foreign Application Priority Data
Jul. 18, 2007 (TW) 96126260

(51) Int. Cl. G06K 19/06; B29C 65/54; B29C 51/42

(52) U.S. Cl. 235/492; 264/272.15; 156/60

(57) ABSTRACT

A method for packaging a smart card is provided. The method includes steps of providing a first thermoforming plastic piece; providing a first piece on the first thermoforming plastic piece and having an aperture; disposing an electrical element on the first thermoforming plastic piece and in the aperture; providing a second thermoforming plastic piece covering the first piece and the electrical element; and heating the first and the second thermoforming plastic pieces.

### FIELD OF THE INVENTION

The present invention relates to a smart card and the packaging method thereof, and more particular to a thin flexible film smart card and the packaging method thereof.

### BACKGROUND OF THE INVENTION

Due to the developing and designing of the micro-electromechanical technique, lots of tiny and portable electronic products are presented to the public, which can be used to deal with things at any time and any place without the fixed, large machine.

The smart card, which is also called an IC card and is a portable plastic card with an IC chip adhered or embedded therein, is appearing in our daily life and is mostly used for identification or as plastic money. Nowadays, the smart cards include the bus card, the postal card, the ID card and the electronic purse which are all designed in a thick form. Such thick card is manufactured by packaging an electrical element with two plastic sheets and then adhering them to be one piece. Please refer to FIG. 1, which is a diagram of the conventional smart card packaging method. This method is performed by packaging an electrical element 12 with two thick plastic sheets 11, 13 and then adhering them to be one piece. Such thick plastic card is large and inflexible. When such thick card is twisted, it is easily broken, and the internal electrical element 12 and the information stored therein are damaged.

A simple method to improve the drawbacks of such thick card is to use the thin plastic sheets instead of the thick ones. However, when the card is adhered, the thickness of the internal electronic element generates a gap between the thin plastic sheets that results in a poor adhering effect and makes the card easily broken. The conventional packaging method is unable to avoid the generation of the gap. Therefore, how to thin the smart card becomes a very important issue.

### SUMMARY OF THE INVENTION

In accordance with an aspect of the present invention, a method for packaging a smart card is provided. The method includes steps of providing a first thermoforming plastic piece; providing a first piece on the first thermoforming plastic piece and having an aperture; disposing an electrical element on the first thermoforming plastic piece and in the aperture; providing a second thermoforming plastic piece covering the first piece and the electrical element; and heating the first and the second thermoforming plastic pieces.

According to the method described above, each of the first and the second thermoforming plastic pieces is a thermoforming plastic membrane.

According to the method described above, the thermoforming plastic membrane is a transparent hot plastic membrane.

According to the method described above, the aperture and the electric element are in the same shape, and an area of the aperture is not smaller than that of the electrical element.

According to the method described above, a thickness of the first substrate is not larger than that of the electrical element.

According to the method described above, the first piece is made of one selected from a group consisting of an adhering agent, a plastic and a thermoforming plastic.

According to the method described above, the adhering agent is a thermosetting adhering agent.

According to the method described above, the electrical element is selected from a group consisting of a printed circuit board, a microprocessor, a radio frequency identification (RFID) circuit, a micro memory device, a liquid crystal display (LCD), a solar cell and a fingerprint sensor.

In accordance with another aspect of the present invention, a method for packaging a smart card is provided. The method includes steps of providing a first substrate; disposing an electrical element on the first substrate; providing an adhering agent on the first substrate and surrounding the electric element; disposing a second substrate over the electrical element; and heating the first and the second substrates.

According to the method described above, the first and the second substrates are made of plastic.

According to the method described above, the plastic is a transparent plastic.

According to the method described above, the adhering agent is a thermosetting adhering agent.

According to the method described above, when the adhering agent is cured, a thickness of the cured adhering agent is equal to that of the electrical element.

According to the method described above, the electrical element is selected from a group consisting of a printed circuit board, a microprocessor, a radio frequency identification (RFID) circuit, a micro memory device, a liquid crystal display (LCD), a solar cell and a fingerprint sensor.

In accordance with a further aspect of the present invention, a smart card is provided. The smart card includes a first piece; a second piece disposed on the first piece and having an aperture; an electrical element disposed on the first piece and in the aperture; and a third piece covering the second piece and the electrical element.

According to the smart card described above, each of the first and the third pieces is made of one selected from a group consisting of plastic, thermoforming plastic and transparent thermoforming plastic.

According to the smart card described above, the aperture and the electrical element are in the same shape, and an area of the aperture is not smaller than that of the electrical element.

According to the smart card described above, the second piece is made of one selected from a group consisting of an adhering agent, a plastic and a thermoforming plastic.

According to the smart card described above, the adhering agent is a thermosetting adhering agent.

According to the smart card described above, the electrical element is selected from a group consisting of a printed circuit board, a microprocessor, a radio frequency identification (RFID) circuit, a micro memory device, a liquid crystal display (LCD), a solar cell and a fingerprint sensor.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram of the conventional smart card package method;

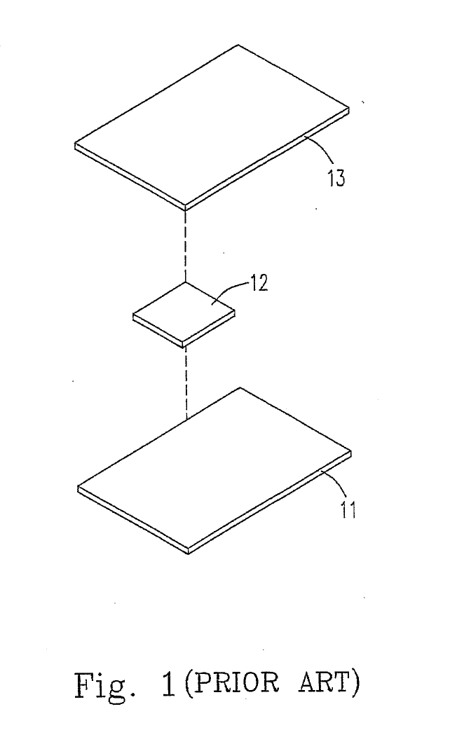

FIG. 2 is a diagram of the smart card packaging method according to a first preferred embodiment of the present invention; and

FIG. 3 is a diagram of the smart card packaging method according to a second preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

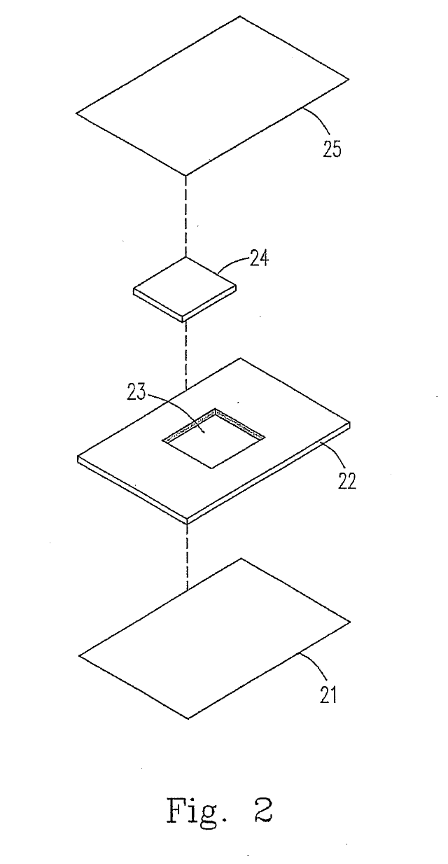

Please refer to FIG. 2, which is a diagram of the smart card packaging method according to a first preferred embodiment of the present invention. The present thin flexible smart card is packaged by using a three-layer packaging method. The first substrate 21 is a thermoforming plastic and used to bear an electronic circuit element 24 and the second substrate 22 with a thickness similar to that of the electrical circuit element 24. Then, the third substrate 25, which is also a thermoforming plastic, is used to cover the electrical circuit element 24 and the second substrate 22. In the above configuration, the second substrate 22 also has an aperture 23 with a similar shape and area to those of the electrical circuit element 24. If there is more than one electrical circuit element 24, the same amount of aperture 23 can be disposed on the second substrate 22 to fit the electrical circuit element 24. Moreover, the thickness of the second substrate 22 is not larger than that of the electrical circuit element 24, so that the gap between the electrical circuit element 24 and the first substrate 21 and that between the electrical circuit element 24 and the third substrate 25 are the smallest. Finally, the assembled card is heated and pressed by using the thermoforming property of the first and the third substrates 21, 25 to make the first and the third substrates 21, 25 adhere to the second substrate 22 respectively, thereby completing the packaging process.

In this embodiment, the first and the third substrates 21, 25 could be made of the thermoforming or the thermoforming transparent material such as the polyethylene (PE), the polypropylene (PP), the polystyrene (PS), the Polymethylmethacrylate (PMMA), the polyvinyl chloride (PVC), the nylon, the polycarbonate, the polyurethane, the polytetrafluoroethylene (PTFE, Teflon), the Polyethylene Terephthalate (PET), the Acrylonitrile Butadiene Styrene (ABS) or the polycarbonate/Acrylonitrile Butadiene Styrene. The second substrate 22 is made of the common plastic or the thermoforming material identical to the first and the second substrates 21, 25. The electrical circuit element 24 could be one of the printed circuit board, the microprocessor, the radio frequency identification (RFID) circuit, the micro memory device, the liquid crystal display (LCD), the solar cell and the fingerprint sensor.

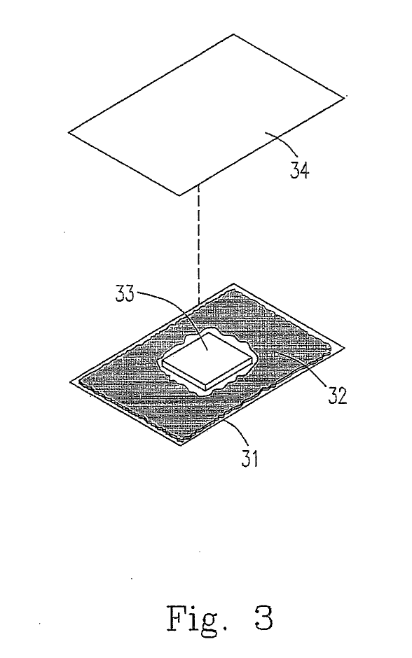

Please refer to FIG. 3, which shows a diagram of the smart card packaging method according to a second preferred embodiment of the present invention. The packaging method in this embodiment is also a three-layer packaging method. The first substrate 31 is used to bear the electrical circuit element 33, and the adhering agent 32 is applied on the first substrate 31 surrounding the electrical circuit element 33. Then, the second substrate 34 is used to cover the electrical circuit element 33. Finally, the assembled card is heated and pressed to cure the adhering agent 32 so that the first substrate 31, the electrical circuit element 33 and the second substrate 34 are adhered to each other to be one piece, thereby completing the packaging process.

In this embodiment, the cured adhering agent 32 has a thickness which is smaller than or equal to that of the electrical circuit element 33, so that the gap between the electrical circuit element 33 and the first substrate 31 and that between the electrical circuit element 33 and the second substrate 34 are the smallest. The first and the second substrates 31, 34 could be made of the common plastic sheets or the transparent plastic sheets. The electrical circuit element 33 could be one of the printed circuit board, the microprocessor, the radio frequency identification (RFID) circuit, the micro memory device, the liquid crystal display (LCD), the solar cell and the fingerprint sensor.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for packaging a smart card, comprising steps of:
providing a first thermoforming plastic piece;
providing a first piece on the first thermoforming plastic piece and having an aperture;
disposing an electrical element on the first thermoforming plastic piece and in the aperture;
providing a second thermoforming plastic piece covering the first piece and the electrical element; and
heating the first and the second thermoforming plastic pieces.

2. A method as claimed in claim 1, wherein each of the first and the second thermoforming plastic pieces is a thermoforming plastic membrane.

3. A method as claimed in claim 2, wherein the thermoforming plastic membrane is a transparent hot plastic membrane.

4. A method as claimed in claim 1, wherein the aperture and the electric element are in the same shape, and an area of the aperture is not smaller than that of the electrical element.

5. A method as claimed in claim 1, wherein a thickness of the first substrate is not larger than that of the electrical element.

6. A method as claimed in claim 1, wherein the first piece is made of one selected from a group consisting of an adhering agent, a plastic and a thermoforming plastic.

7. A method as claimed in claim 6, wherein the adhering agent is a thermosetting adhering agent.

8. A method as claimed in claim 1, wherein the electrical element is selected from a group consisting of a printed circuit board, a microprocessor, a radio frequency identification (RFID) circuit, a micro memory device, a liquid crystal display (LCD), a solar cell and a fingerprint sensor.

9. A method for packaging a smart card, comprising steps of:
providing a first substrate;
disposing an electrical element on the first substrate;
providing an adhering agent on the first substrate and surrounding the electric element;
disposing a second substrate over the electrical element; and
heating the first and the second substrates.

10. A method as claimed in claim 9, wherein the first and the second substrates are made of plastic.

11. A method as claimed in claim 10, wherein the plastic is a transparent plastic.

12. A method as claimed in claim 9, wherein the adhering agent is a thermosetting adhering agent.

13. A method as claimed in claim 9, wherein when the adhering agent is cured, a thickness of the cured adhering agent is equal to that of the electrical element.

14. A method as claimed in claim 9, wherein the electrical element is selected from a group consisting of a printed circuit board, a microprocessor, a radio frequency identification (RFID) circuit, a micro memory device, a liquid crystal display (LCD), a solar cell and a fingerprint sensor.

15. A smart card, comprising:
a first piece;
a second piece disposed on the first piece and having an aperture;
an electrical element disposed on the first piece and in the aperture; and
a third piece covering the second piece and the electrical element.

16. A smart card as claimed in claim 15, wherein each of the first and the third pieces is made of one selected from a group consisting of plastic, thermoforming plastic and transparent thermoforming plastic.

17. A smart card as claimed in claim 15, wherein the aperture and the electrical element are in the same shape, and an area of the aperture is not smaller than that of the electrical element.

18. A smart card as claimed in claim 15, wherein the second piece is made of one selected from a group consisting of an adhering agent, a plastic and a thermoforming plastic.

19. A smart card as claimed in claim 18, wherein the adhering agent is a thermosetting adhering agent.

20. A smart card as claimed in claim 18, wherein the electrical element is selected from a group consisting of a printed circuit board, a microprocessor, a radio frequency identification (RFID) circuit, a micro memory device, a liquid crystal display (LCD), a solar cell and a fingerprint sensor.
